(19) United States
(12) Patent Application Publication
(10) Pub. No.: US 2023/0042867 A1
(43) Pub. Date: Feb. 9, 2023

(54) AUTONOMOUS ELECTRIC MOWER SYSTEM AND RELATED METHODS

(71) Applicant: Graze, Inc., Santa Monica, CA (US)

(72) Inventors: Nicholas Degnan, Redondo Beach, CA (US); Arthur Levy, Los Angeles, CA (US); Martin Buehler, Sherman Oaks, CA (US); Amar Jyothiprakash, Los Angeles, CA (US); Michael Lui, Cerritos, CA (US); Krystof Litomisky, Studio City, CA (US); Manomit Bal, Playa del Rey, CA (US); Blake Edward Winner, Los Angeles, CA (US)

(21) Appl. No.: 17/874,906

(22) Filed: Jul. 27, 2022

Related U.S. Application Data
(60) Provisional application No. 63/226,610, filed on Jul. 28, 2021.

(51) Int. Cl. A01D 34/86; A01D 34/00; A01D 34/54; G05D 1/02; G05D 1/00; G06V 20/56; G06V 10/70

(52) U.S. Cl. CPC A01D 34/863; A01D 34/008; A01D 34/54; G05D 1/0214; G05D 1/0219; G05D 1/024; G05D 1/0248; G05D 1/0257; G05D 1/0016; G05D 1/0061; G06V 20/56; G06V 10/70; A01D 2101/00

(57) ABSTRACT

An autonomous electric mower for mowing a lawn comprises a frame, drive wheels, cutting deck, computer, a Lidar sensor, at least one color and depth sensing camera. The computer is programmed and operable to: determine the location of the mower; detect obstacles; and to instruct the mower to avoid the obstacles. Advantageously, the system is operable to analyze the data from the multiple sensors and to instruct the mower to continue to safely operate and cut the lawn despite one or more of the sensors being obstructed. Novel route planning methods are also described.

### CROSS-REFERENCE TO RELATED APPLICATIONS

This application claims priority to provisional patent application No. 63/226,610, filed Jul. 28, 2021, and entitled “AUTONOMOUS ELECTRIC MOWER SYSTEM AND RELATED METHODS”, the entirety of which is incorporated herein by reference for all purposes.

### BACKGROUND

### 1. Field of the Invention

The invention relates to lawn mowers and more particularly to autonomous electric lawn mowers.

### 2. Description of the Related Art

Commercial lawn mowers are subject to heavy non-stop use and must be capable of mowing large areas including sloping or uneven grounds. Currently available mowers generally lack intelligence, are gas powered, have noisy combustion engines, and require a rider on top to steer the vehicle across the lawn.

Commercial lawn mowers face a number of challenges arising from the rider/operator including: consistency/quality of mowing (e.g., manual operation is subject to large variability); wear and tear on mower (e.g., damage to mower due to careless operations); injuries (e.g., driving, roll-over, collisions, blade accidents, etc.); and speed/efficiency (e.g., route planning as well as down time arising from rider employee breaks for restrooms, food, refueling, or resting).

Additionally, use of gas powered engines raises a number of other types of problems including: noise (for operator, for bystanders, or for residents); noxious emissions (for operator, for bystanders, or for residents); environmental impact (its emissions contribute to global warming, and pollutants of PM10, PM2.5 can have adverse health effects); regulatory pressure (arising from regulatory agencies seeking to curb gas (e.g., CO2) and other types of harmful emissions); and reliability (arising from use of pulleys, belts, hydraulics, and other complexities and maintenance needs of gas engines such as spark plugs, throttle, starting problems, etc.).

Consequently, there is a need for improved mower systems that address the above-mentioned challenges.

### SUMMARY

An autonomous electric mower for mowing a lawn comprises: a frame; drive wheels; a cutting deck; a computer; a Lidar sensor; at least one depth sensing camera; and at least one color camera; an inertial measurement unit, and optionally, a GPS. The computer is operable, based on the data generated from each of the Lidar sensor, depth sensing cameras, color cameras, and IMU and GPS if present, to: determine the location and path of the mower; detect an obstacle; and to instruct the mower to avoid the obstacle or continue on its path.

In embodiments, the mower includes a control system comprising one or more controllers and other hardware and software for controlling the various motors, actuators, sensors, and cameras. The control system may have a computer or processor framework, memory, power supply, and other modules as described herein. In embodiments, components are used for multiple functions. For example, the data from the lidar camera may be used for perception, localization, and navigation. In alternative embodiments, a functional module can have a dedicated set of sensors and electronics for carrying out solely its function such as obstacle detection, navigation, or perception.

In embodiments, an autonomous vehicle system includes a perception stack, localization stack, and a navigation stack. The perception stack includes a plurality of sensors and is operable to detect and classify a wide range of obstacles. In preferred embodiments, the perception stack can evaluate and weight the sensor data to increase precision or otherwise enhance the data. For example, two different cameras may be arranged to have overlapping fields of view and the system is operable to exclude camera data that is obstructed or otherwise of poor quality. The system weights the unobstructed data more heavily. More accurate predictions can be made with this refined data.

In embodiments, the localization stack can comprise at least one sensor and electronics for estimating the location of the vehicle. An exemplary location sensor is a GPS system. The localization stack preferably can compute the local and global position based on the various sensor data.

In embodiments, a navigation stack comprises a boundary planner, lawn coverage planner, and navigation controller. In embodiments, the navigation controller is operable to dynamically combine the information from the perception and the localization stacks to create a dynamic decision tree for safely and efficiently driving the vehicle along the planned route while avoiding obstacles. In embodiments, the navigation stack is operable to create an optimum boundary, create an optimum cut pattern, steer the vehicle along the predetermined route at the correct speed, and to control the cut parameters to achieve the desired pattern (e.g., grass cut height, blade speed, etc.).

In embodiments, the computer is operable to compute a boundary or outline of the target mowing area based on user input. The user may trace the target area by actually driving the mower around the target area or virtually by marking the target area on a display. The computer is operable to record a plurality of points as the mower is being driven (whether actually on the lawn or virtually on the display) along the boundary and to obtain location information for each recorded point. In embodiments, the computer fits a two-dimensional geometric shape such as a polygon to the recorded points. Optionally, the computer is operable to update the boundary shape as each new point is recorded.

In embodiments, the computer is programmed and operable to determine a route for the mower to mow the entire target area based on the computed boundary and various other inputs including but not limited to mowing pattern or angle, number of turns, completion time, mower recharge or maintenance time, turn locations, and grass height. In embodiments, the system computes a plurality of different routes to present to the user and displays each route and associated metrics for each route such as completion time, mowing efficiency, power efficiency, number of turns, angle or mowing pattern, grass height according to area, etc. Optionally, the computer is programmed or operable to generate a 2D or 3D virtual view of at least a portion of the target area showing the anticipated post-cut lawn and the anticipated cut pattern in view of the route, turns, grass height, and mowing pattern or angles.

In embodiments, a traction controller is arranged on the frame and responsive to the computer to provide a desired amount of current to each wheel drive motor based on the desired speed for the vehicle. The speed may be input by the user or automatically computed based on the planned route to optimize mowing efficiency (e.g., area mowed per hour) or power (e.g., area mowed per Watt).

In embodiments, a cutting deck includes spinning cutting blades and an independent electric cutting motor for each of the blades. A cutting controller is arranged on the deck and responsive to the computer to provide a desired amount of current to each cutting motor based on the desired cutting speed. The blade cutting speed may be input by the user or automatically computed to achieve an acceptable power draw, and/or to reduce the mowing completion time.

In embodiments, the cutting deck includes one or more actuators to adjust the height of the cutting plane relative to the ground. A dedicated blade (or grass height) adjustment controller is arranged on the deck and responsive to the computer to provide a desired amount of current or voltage to each actuator in order to automatically raise the cutting plane to a desired height from the ground, or stated alternatively, to provide a desired grass height. The grass height may be input by the user or automatically computed to achieve an acceptable power draw, and/or to reduce the mowing completion time.

In embodiments, the computer is operable to optimize mowing efficiency (e.g., to reduce the time to mow the entire target area, or to utilize the least amount of energy) by automatically adjusting multiple mowing inputs. Examples of mowing inputs include, without limitation, the blade cutting plane, blade speed, vehicle speed, threshold power or draw allowed, the route, and characteristics of the route plan (e.g., overlap, angles, turn locations, etc.). In embodiments, the cutting may commence at a first minimum cutting height, blade speed, and vehicle speed and each of the inputs are incrementally raised (or lowered as the case may be) until a threshold power level, another measurable output, or aggregate score is computed. If the output or score falls within a desired or threshold range, the mowing continues. If the output or score is outside the desired range, one or more of the inputs are adjusted in real time until the output is within the desired range. For example, in embodiments, the (a) height of the cutting blade plane is raised in combination with (b) reducing the vehicle speed until the power draw is lowered to within an acceptable range. In embodiments, an acceptable range for the power draw is from 4 kW to 8 kW, and more preferably 4 kW to 6 kW.

Embodiments of the invention include redundant sensing of areas surrounding the mower in the event one or more of the sensors are obstructed. A computing system is operable to analyze the data from the multiple sensors and to instruct the mower to continue to safely operate and cut the lawn despite one or more of the sensors being obstructed. Optionally, the mowing system is operable to safely stop if the obstructions or sensor occlusions are deemed to not allow the mower to continue safe operations.

In embodiments, the Lidar sensor is arranged on the mower to have a 360-degree view from the vehicle body.

In embodiments, the Lidar sensor is arranged on the vehicle to detect medium and far range distances, and the depth sensing cameras are arranged on the vehicle to detect near range distance that is not detected by the Lidar sensor (e.g., a Lidar blind spot arising from self-occlusion where the Lidar beams hit the body or mow deck).

In embodiments, the Lidar sensor is arranged on the vehicle at a height from the ground of greater than 2 ft, and more preferably greater than 3 ft, and in one particular embodiment, the Lidar sensor is arranged on the vehicle at a height from the ground of about thirty-five (35) inches.

In embodiments, the mower or vehicle system further comprises radar, and wherein the computer is programmed and operable to determine obstacle and optionally, location information based on the radar. Examples of types of radar include impulse and frequency modulated continuous wave radar. The radar can be operated at different frequencies including, for example, short range radar, medium range radar, and long-range radar serving different functions. The radar can be used for a wide variety of functions including but not limited blind-spot monitoring, obstacle detection, position, and navigation.

In embodiments, a non-transient storage comprises a computer readable set of instructions stored thereon for path planning, navigation and obstacle avoidance, and controlling one or more autonomous electric mowers.

The description, objects and advantages of the present invention will become apparent from the detailed description to follow, together with the accompanying drawings.

### BRIEF DESCRIPTION OF THE DRAWINGS

FIG. 1A is a perspective view of an AEM system including a mowing vehicle and mowing cutting deck in a deployed orientation in accordance with an embodiment of the invention;

FIG. 1B is a perspective view of another AEM system shown in a lifted orientation in accordance with an embodiment of the invention;

FIGS. 2A-2B are top views of lower and upper vehicle levels of the mowing vehicle with the cover removed in accordance with an embodiment of the invention;

FIGS. 3A-3B are partial top and rear views respectively of a mowing vehicle with the cover removed in accordance with an embodiment of the invention;

FIG. 4 is an enlarged view of the sealed outputs shown in FIG. 3B in accordance with an embodiment of the invention;

FIG. 5A is an exploded view of the cutting deck shown in FIG. 1A in accordance with an embodiment of the invention;

FIG. 5B is an exploded view of another cutting deck including an actuator for adjusting the height of the cutting plane in accordance with an embodiment of the invention;

FIG. 6 is a flow diagram of an AEM method in accordance with an embodiment of the invention;

FIG. 7 is a power supply diagram of an AEM system in accordance with an embodiment of the invention;

FIG. 8A is a circuit diagram of an AEM system in accordance with an embodiment of the invention;

FIG. 8B is a circuit diagram of an AEM system in accordance with another embodiment of the invention;

FIG. 9A is a sensor interface diagram of an AEM system in accordance with an embodiment of the invention;

FIG. 9B is a sensor interface diagram of an AEM system in accordance with another embodiment of the invention;

FIGS. 10-12 illustrate various screen shots for a graphical user interface in accordance with an embodiment of the invention;

FIG. 13A is a block diagram of a software system of an AEM system in accordance with an embodiment of the invention;

FIG. 13B is a block diagram of another software system of an AEM system in accordance with an embodiment of the invention;

FIG. 14A is a block diagram of a perception software system of an AEM system in accordance with an embodiment of the invention;

FIG. 14B is a block diagram of another perception software system of an AEM system in accordance with an embodiment of the invention;

FIG. 15 is an illustration of an AEM system and sensor coverage in accordance with an embodiment of the invention;

FIG. 16 is a block diagram of a location software system of an AEM system in accordance with an embodiment of the invention;

FIG. 17 is a flow diagram of a path planning software system of an AEM system in accordance with an embodiment of the invention;

FIG. 18 is a block diagram of a state machine software system of an AEM system in accordance with an embodiment of the invention; and

FIG. 19 is a block diagram of a cloud-based system of an AEM system in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as an antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

Mower Overview

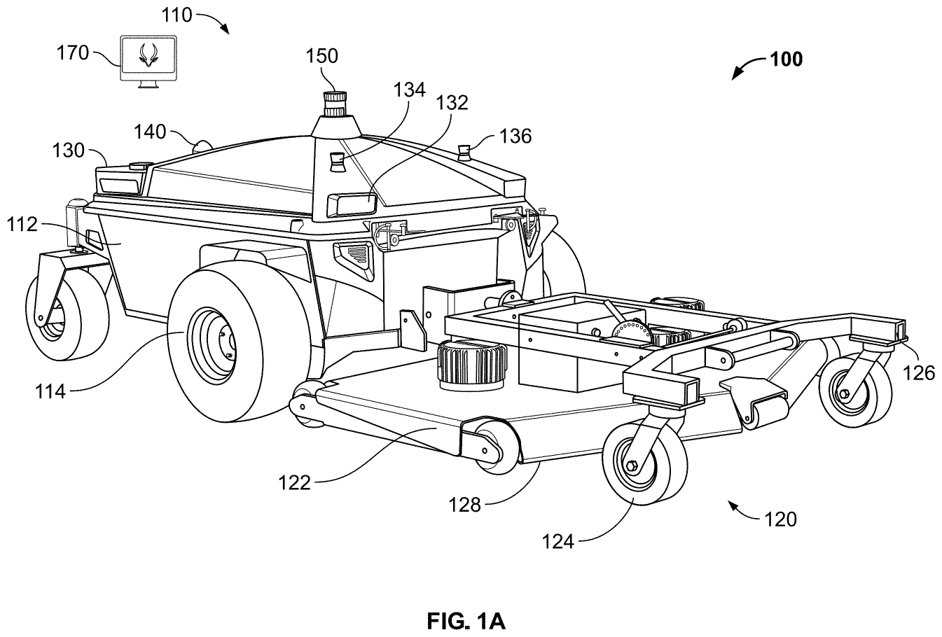

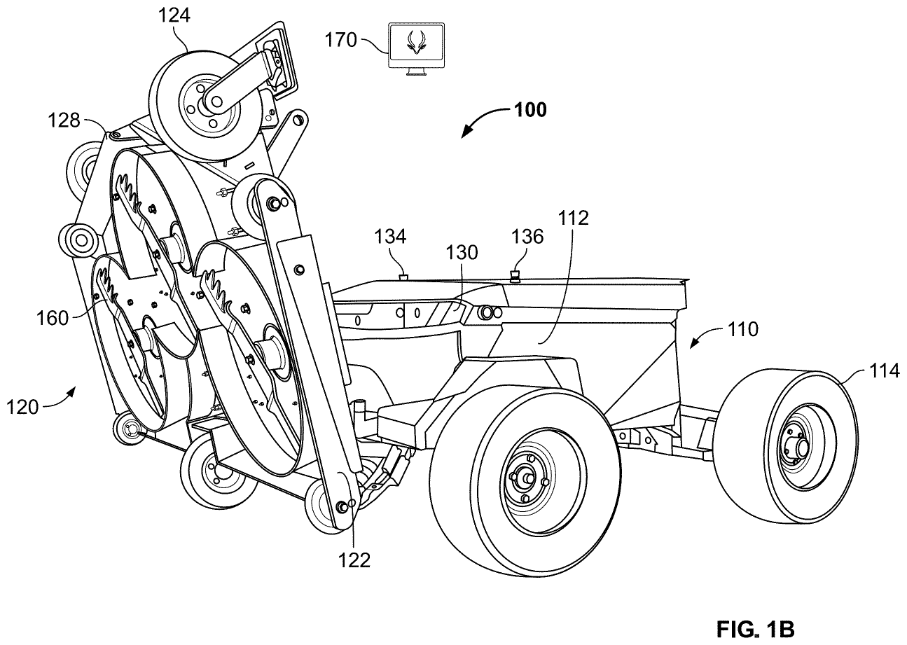

FIG. 1A is an illustration of an AEM system 100 in accordance with one embodiment of the invention. The system 100 is shown having a vehicle 110 and a cutting deck 120 coupled to the front of the vehicle. In preferred embodiments, the cutting deck 120 is detachably coupled to the vehicle by a hitch and a hitch electrical connector, discussed herein.

The vehicle 110 is shown having an enclosure 112; wheels 114 (preferably run flat tires); cameras 130; E-stops 134, 136; GPS 140; LIDAR 150; and lights 132. Not shown is an inertial measurement unit (IMU). Enclosure 112 houses a number of hardware and software components (not shown) including but not limited to a chassis, brakes, battery cells, processors, motors, controllers, connectors, and communication interfaces.

Cutting deck 120 is shown having anti-scalping mechanism 122, wheels 124, steering rack 126, and cover 128 for housing the rotatable blades (not shown) and discussed further herein.

Preferably, the vehicle 110 and cutting deck 120 of the AEM system are collectively operable to autonomously mow an entire lawn area within a boundary while detecting and avoiding obstacles. However, as described herein, the vehicle 110 may also be controlled manually or by a command center 170, whether local or remote.

FIG. 1B is an illustration of an AEM system 100 in a lifted configuration where reference numerals in common with that shown in FIG. 1A are meant to represent the same component and carry out the same function to the component described in FIG. 1A except where the context indicates otherwise. The system 100 is shown having a 4-wheeled vehicle 110 and a cutting deck 120 coupled to the front of the vehicle. The deck 120 has been lifted to expose the blades 160 for maintenance, for example. In preferred embodiments, the cutting deck 120 is detachably coupled to the vehicle by a hitch and a hitch electrical connector, discussed herein.

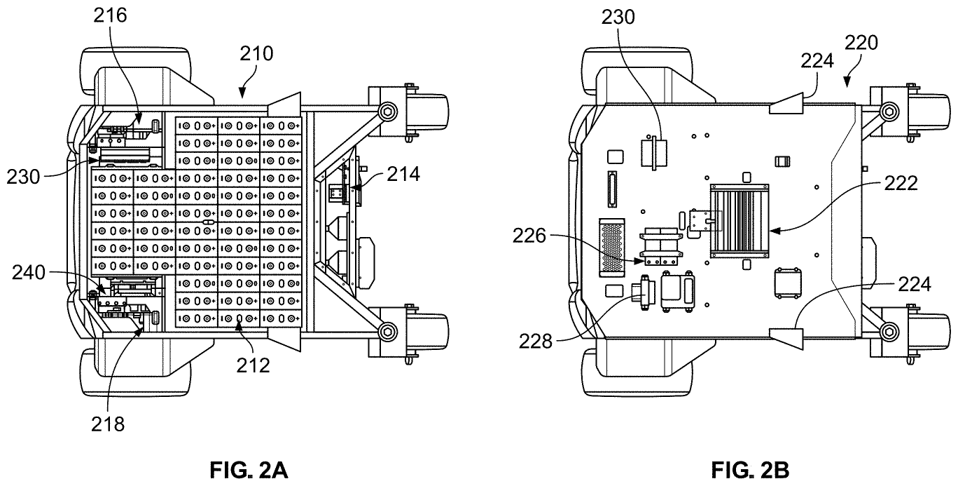

FIGS. 2A-2B show lower level 210 and upper level 220 of a vehicle in accordance with an embodiment of the invention with the outer enclosure removed for clarity.

With reference to FIG. 2A, lower level 210 is shown supporting 48 battery cells 212. However, it is to be understood that the number of battery cells may vary except as where recited in any appended claims.

Charging port 214 is shown at the rear of the vehicle.

Electric motors 216, 218 are shown coupled to front wheels. Traction controller 230 and battery management system (BMS) 240 are also mounted to lower-level frame.

With reference to FIG. 2B, upper level 220 shows computer 222, cameras 224, battery cells 226 and 24 V and 48 power distribution units (PDUs) 228, 230.

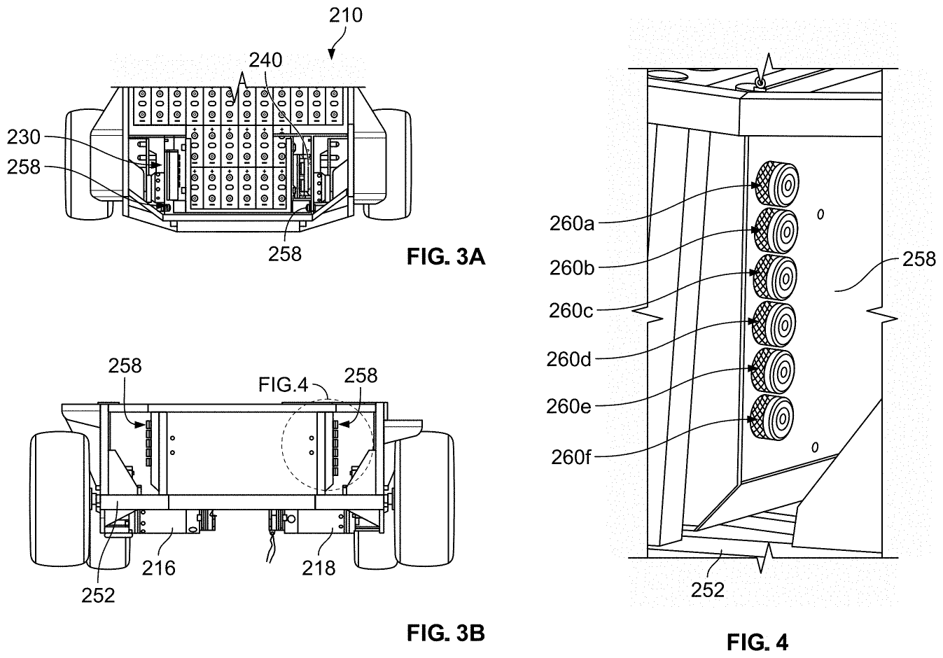

FIG. 3A shows a partial top view of lower level 210 of the vehicle with the upper level and enclosure removed. FIG. 3B shows a front view of the vehicle with the enclosure removed.

With reference to FIGS. 3A, 3B, traction motors 216, 218 are shown supported by chassis 252 and coupled to wheels. Traction motor controller 230 is mounted to the chassis on the upper level. Each side is shown having a dashboard 258 for sealed outputs 262a, b, c, d, e, f.

In embodiments, as discussed herein, the computer is operable and programmed to independently control the speed of each drive wheel, thus controlling the vehicle ground speed as well as steering.

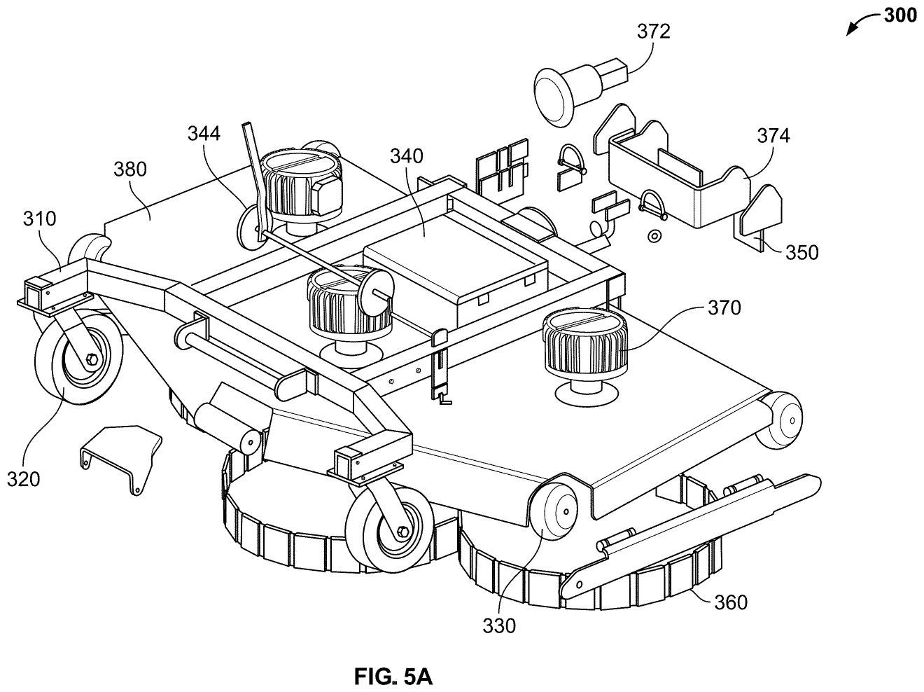

FIG. 4 is an enlarged view of the front left side of the vehicle shown in FIG. 3B.

Dashboard 258 includes 6 outputs including left motor positive 260a, left motor negative 260b, traction encoder 260c, traction brake 260d, deck power 260e, and deck aux signals 260f.

Cutting Deck Detail

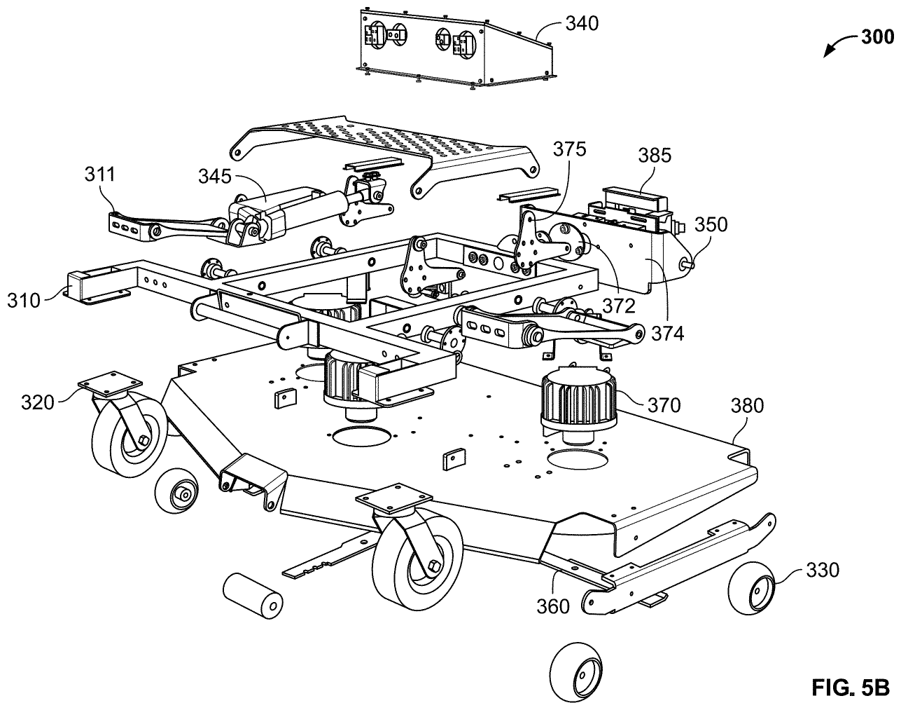

FIG. 5A shows an exploded view of a mowing cutting deck 300 in accordance with an embodiment of the invention. The mowing cutting deck 300 shown in FIG. 5A includes frame 310, castor wheels 320, anti-scalping mechanism 330, deck electronics 340, height adjustment mechanism 344, hitch connector 350, blade container 360, blade motor(s) 370, automatic contour adjustment/roll joint 372, pivot joint 374 and cover 380.

As described herein, the deck electronics 340 are operable with the electronics of the mower vehicle 110 to control cutting. Examples of controlling cutting include: start, stop, and blade speed.

Additionally, a height adjustment mechanism 344 is operable to raise and lower the cover 380 relative to the frame 310 thereby adjusting the blades 360 to cut the grass to a desired (and tunable) height. The height adjustment shown in FIG. 5A is manual, however, the invention may also include an automatic height adjustment module including an actuator, and deck electronics to raise and lower the cover 380, described herein.

With reference to FIG. 5B, a mowing deck including an automatic height adjust module is shown where reference numerals in common with that shown in FIG. 5A are meant to represent the same component and carry out the same function to the component described in FIG. 5A except where the context indicates otherwise. Particularly, deck 300 is shown having actuator 345 for adjusting the height of the frame 310 instead of the manual arm 344 system shown in FIG. 5A. Sway bar 311 is a pivoting arm that provides rigidity in the horizontal plane to the blade cover 380. If the height adjustment is automatic as in the example shown in FIG. 5B, the mower can automatically make adjustments based on user preference or field conditions as detected by the mower. For example, a golf-course landscaping supervisor may desire to mow different parts of the course at different heights. The mower could store this information in its memory, and automatically cut the grass at the desired cut height as it enters each mow area, which greatly increases the efficiency of landscaping operations.

In embodiments, the mower automatically adjusts the deck height based on conditions and the planned route. For example, in embodiments, the mower raises the deck before the beginning of each turn, and lowers it after the end of each turn, in order to decrease the possibility of damage to the grass and reduce strain on the mower's motors. This automates a process that is manually performed by human operators in certain situations requiring particularly low grass cut heights.

In embodiments of the invention, the mower evaluates the height of the grass for cutting using the sensors or cameras. If the grass is too long to directly cut to the desired height, which may be harmful to the health of the grass, the mower automatically mows the grass to a higher cut height. The mower can return after a few days to mow the grass again to the ultimate desired cut height. Cutting the grass incrementally improves the health of the grass.

As shown, the mowing deck 300 preferably includes anti-scalping wheels 330 which are coupled to the cover 380 such that the blade assemblies 360 are prohibited from scalping the grass.

As discussed herein, a hitch or mount 374 serves to physically detachably connect the deck 300 to the main mowing unit or robotic vehicle 110 shown in FIGS. 1A-1B. In embodiments, the mechanical interface 374 to the mowing deck 300 comprises a main connection shaft 372 and a set of secondary connection points 350 connecting to the main shaft 372 for a secure mounting of the attachment while allowing the pitch angle of the attachment to be unrestrained.

[symbol]

Preferably, the deck is operable to conform to a wide range of contours, automatically adjusting the height of the multiple blade assemblies 360. In the embodiment shown in FIGS. 5A-5B, the deck includes a roll joint 372 and a pitch joint 350 so as to allow the deck to be pushed or pulled (and in embodiments, steered) by the mower along various sloping terrains while maintaining each blade assembly predictably and accurately spaced at the desired height from the ground. Indeed, the joints 350, 372 allow for the deck to tilt forward and back as well as from side to side.

Not shown is an electronic connector to connect power and signals and data transfer between the deck and the mower. In embodiments, the electrical interface to the mowing deck consists of 3 connections, a high-power connection for the system's actuation, a low-level power connection for digital signal exchange, and a control area network bus (CANBUS) connection. In embodiments, the blade motor controllers relay blade speed and current draw information upstream, which is then used as a form of closed loop control from the high-level computer (e.g., computer 222) to (a) optimize and maintain the blade speed required to procure an optimal grass cut quality regardless of resistance and (b) to detect aberrant behavior and stop the blades as a factor of safety. For example, if the blade speed or power draw exceeds a threshold amount the computer commands the blade motors to halt.

Method for Mowing Overview

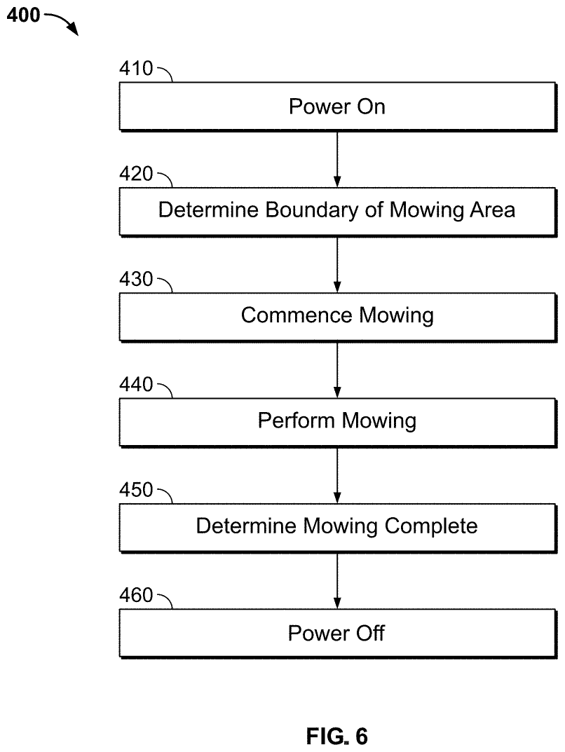

FIG. 6 is a flow chart illustrating an overview of a mowing method 400 in accordance with an embodiment of the invention. As the steps of the method 400 are described herein, reference may be made to one or more of the other figures for illustrating non-limiting exemplary hardware components or software modules for carrying out the steps of the method. However, the invention is not intended to be limited to solely the method set forth in FIG. 6, and any combination of the components, steps and teachings set forth herein are intended to be combinable except where such combinations are exclusive of one another.

With reference again to FIG. 6, step 410 states to turn on the AEM system 100. In embodiments, the system 100 includes a power on switch on the vehicle 110.

Step 420 states to determine the boundary of the mowing area. The boundary of the mowing area can be determined in various manners. For example, a candidate boundary may be loaded or selected from a database of predetermined or confirmed boundaries based on, e.g., the instant GPS location of the mower. The user can confirm the candidate boundary.

In embodiments, the boundary is created by tracing a perimeter of the target mowing area by driving the mower system along the perimeter using the manual control, described herein. The perimeter locations are detected by the onboard sensors and cameras and the boundary is stored.

In another embodiment, the boundary is created by virtually tracing the perimeter of the target area on a display using an application on a PDA, smartphone, tablet, computer, or on-robot computer. For example, a software application can be operable to provide a satellite view (or another upper view-like illustration) of the robot's surroundings and allow the operator to designate (e.g., by drawing or marking) the desired boundary or portion thereof.

Still, in other embodiments, the boundary is created by driving the mower along at least a portion of the perimeter of the target area and a plurality of points and their location information are recorded. The computer fits a geometric shape (such as a polygon) to the recorded points that encloses the target mowing area. Optionally, as each new point is added, the boundary shape is updated until the user confirms the boundary is acceptable.

In embodiments, the robot is operable to perform (optionally, automatically) a second or boundary refining step. The computer refines the boundary of the mow area as initially drawn (e.g., drawn on the display) by the user into a more precise boundary using its perception sensors and artificial intelligence. For example, the boundary points input by the user using a satellite view has limited resolution and accuracy. The robot can automatically identify the edges of a mowable lawn using its cameras and sensors, and follows these edges near the approximate boundary provided for the user. This works for both external boundaries, such as the boundary between a lawn and a flowerbed, and internal boundaries, such as paved walkways, trees, or other obstacles in the middle of a lawn. Thus, in embodiments, the initial high-level user input to create a first boundary is turned into a reliable, more precise mowing boundary, greatly increasing the efficiency of the overall mowing and landscaping process.

Not shown, in embodiments, the robot computer is programmed to automatically compute or suggest mowing patterns for the target area including number of turns, angle, obstacles to avoid (e.g., patio or pond), etc. The boundary and pattern can be presented to the user for confirmation or adjustments.

Step 430 states to instruct the AEM system 100 to commence mowing. Examples of embodiments to perform step 430 include to instruct the mower to begin mowing via a controller (via wired or wireless), a web application, or an on-board device (e.g., a touchscreen).

Step 440 states to perform mowing. The AEM system 100 automatically performs mowing safely, accurately, and efficiently to complete mowing of the entire area as defined by the boundary, determined above. In preferred embodiments, the mowing step is performed according to the planned route computed above as well as executing an obstacle recognition and avoidance plan, described further herein.

Step 450 states mowing is complete. The AEM system detects when mowing is complete and communicates to the operator that mowing is complete. Examples of communication include audio forms such as honking a horn on the vehicle 100 or sending a notification to any open web application, such as an application on the operator's smartphone, tablet or computer. The computer (with optional touch screen) can also be located on the robot.

Optionally, the operator can direct the AEM system to a new mowing area and commence mowing in another area.

Additionally, in embodiments, the mower is set to mow multiple areas one after the other, and to automatically drive between them. The operator can thus setup the robot to fully autonomously mow multiple mowing areas within a single geographical area. By operating fully autonomously during this entire process, which can span hours of time and acres of mowing, the robot greatly increases the efficiency of mowing operations.

Step 460 states to power off the AEM system. As described above, this step may be performed, for example, by a power switch on the vehicle itself, or an App on the smartphone, tablet or computer.

Block Diagrams

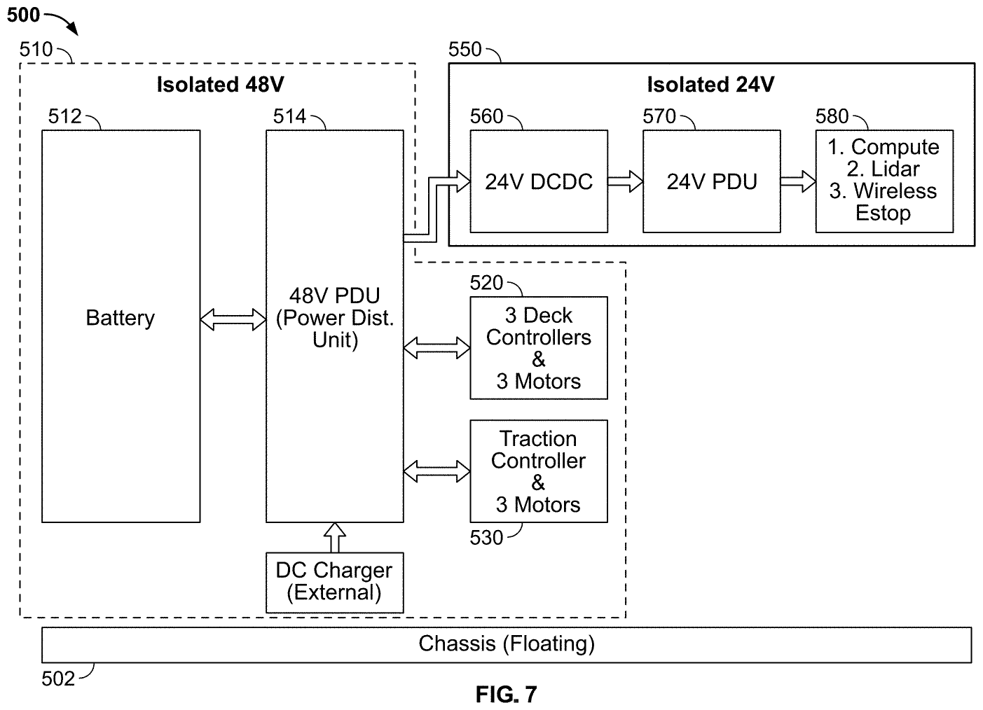

FIG. 7 is a power supply diagram of an AEM system 500 in accordance with an embodiment of the invention. A first or high-power system 510 is shown isolated from the second or lower voltage system 550, both supported by floating chassis 502.

The high-power system is preferably 48 V, and includes a 48 V PDU 514 which delivers the current to deck controllers and motors 520 and the traction controller and motors 530.

The lower power system 550 is preferably 24 V and operable to supply power to the computer, sensors, and wireless estop (collectively 580), discussed herein, via 24 V PDU 570.

An external charger (DC charger) is shown to charge the battery pack. Preferably, the charger is adapted to be connected to a standard outlet (e.g., 120 or 240 V).

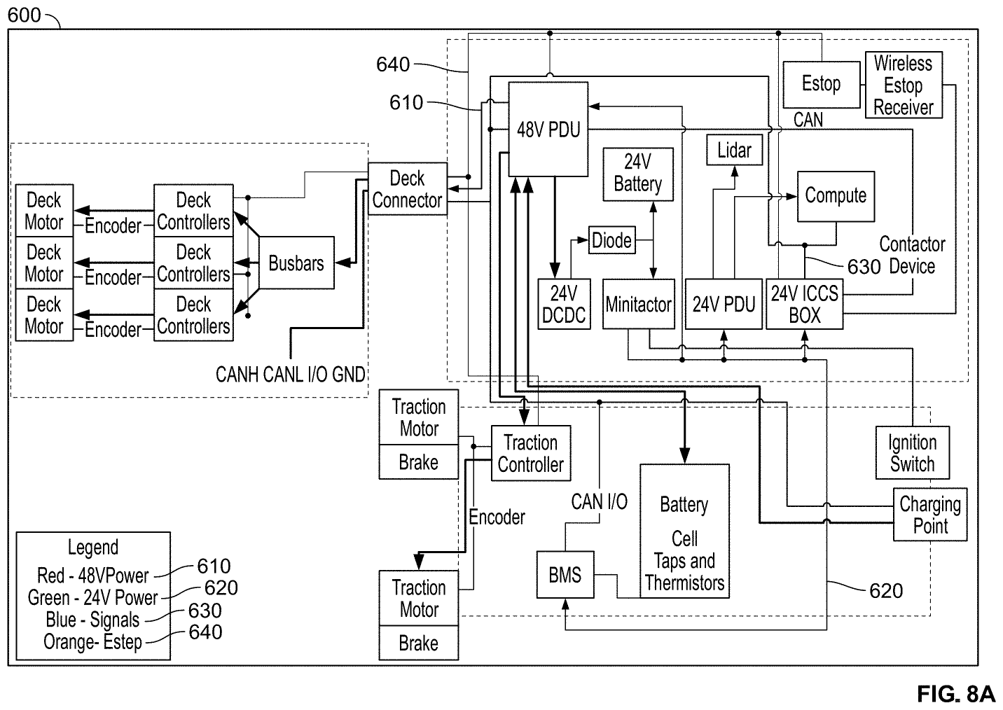

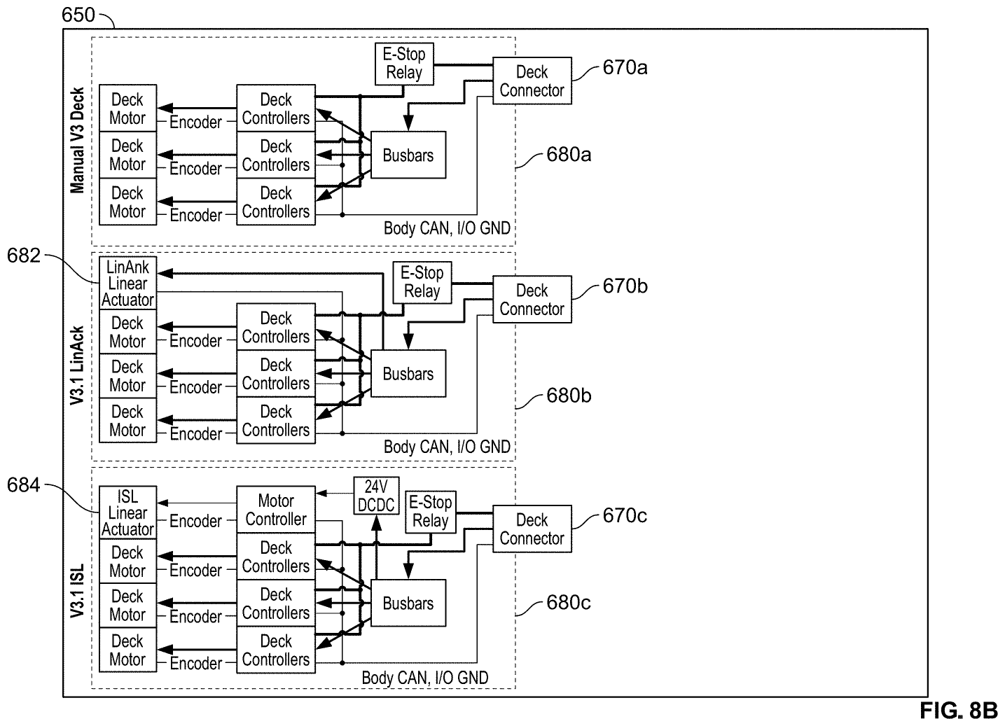

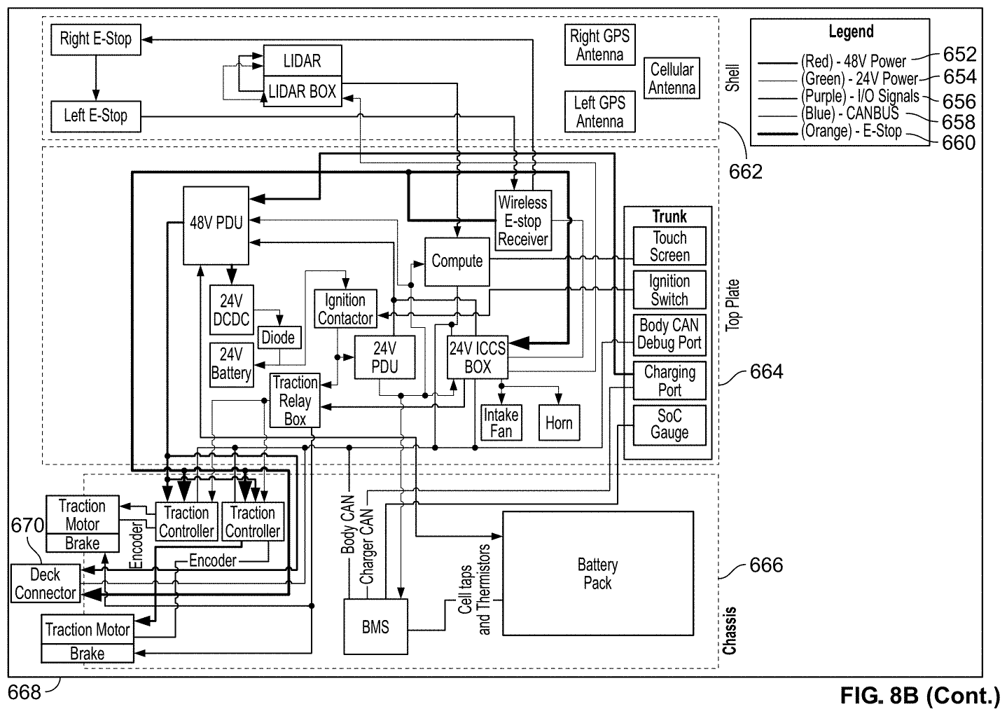

FIG. 8A is a circuit diagram of an AEM system 600 in accordance with an embodiment of the invention. Four circuits are shown in FIG. 8A including 48V 610, 24V 620, signal 630, and estop 640.

FIG. 8B is a circuit diagram of another AEM system 650 in accordance with another embodiment of the invention. Five circuits are shown in FIG. 8B including 48V (652), 24V (654), signal (656), CANBUS (658), and estop (660).

Three different types of deck circuits 680a, 680b, and 680c are shown in FIG. 8B including a high-power cutting deck with a manually-operated lift, a deck 680b with a first type of electric linear actuator 682, and a deck 680c with a second type of linear actuator 684 including a dedicated power source and controller.

Each deck circuit 680a, 680b, and 680c is shown with a deck connector 670a, 670b, and 670c respectively which can be detachably coupled to the main robotic unit 668 as described herein.

The main robotic unit 668 is shown organized according to a shell/enclosure 662, top plate 664, and chassis 666.

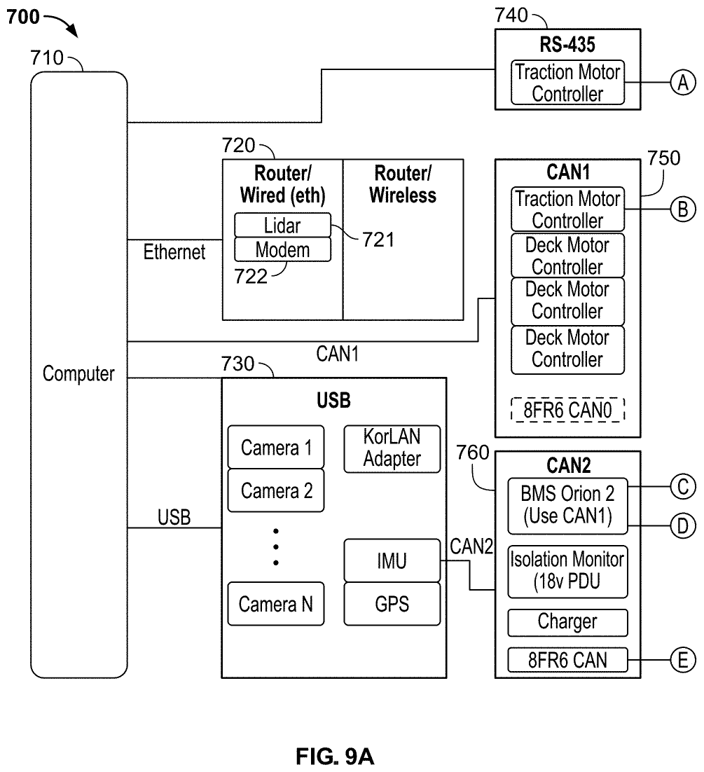

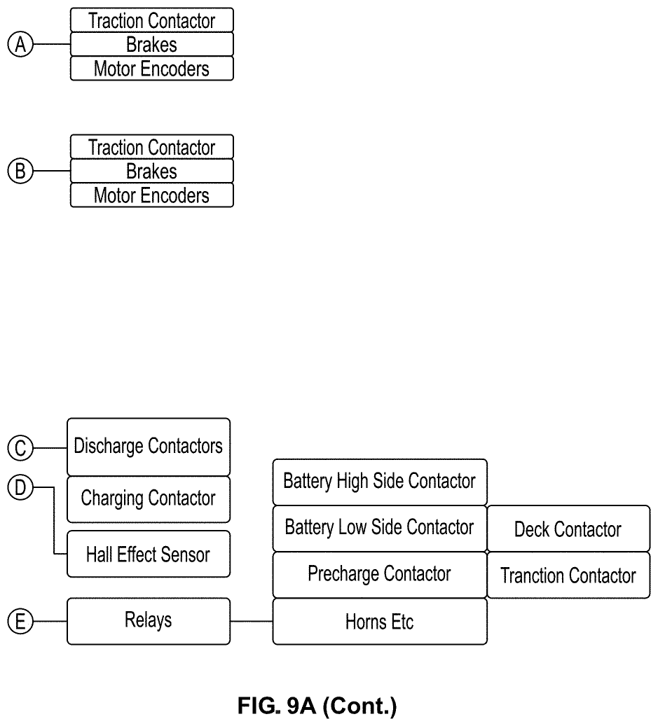

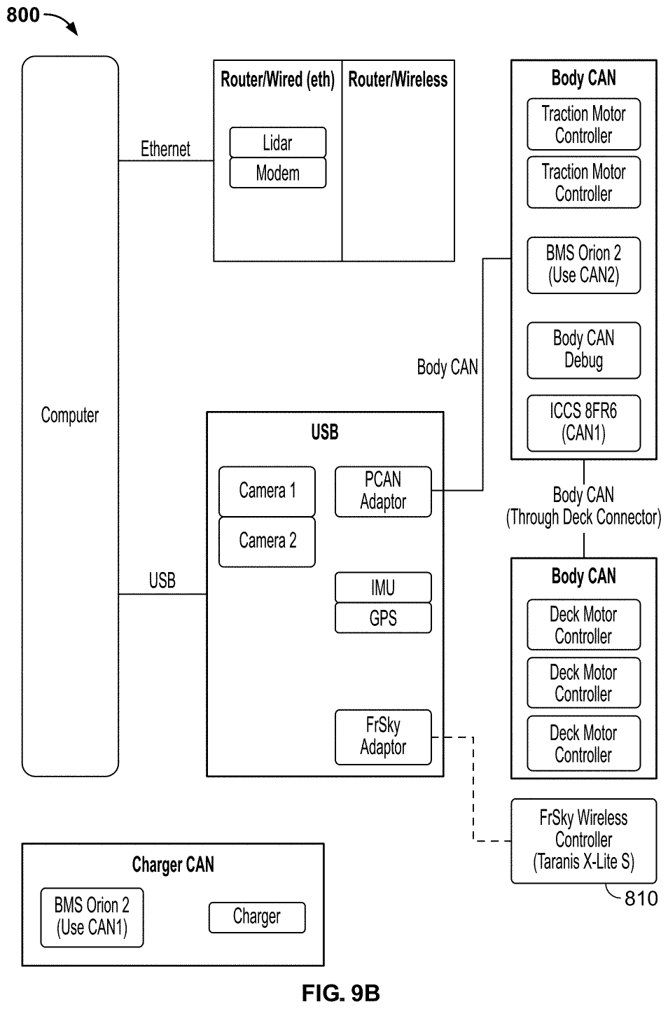

FIG. 9A is a sensor interface diagram of an AEM system 700 in accordance with an embodiment of the invention. A computer or processor 710 such as, e.g., a NUC computer manufactured by OnLogic Inc. (South Burlington, Vt.) is shown operable to receive sensor data from LIDAR 720 via ethernet. An exemplary Lidar sensor 721 is the OS1, manufactured by Ouster Inc. (San Francisco, Calif.). The data is shown being communicated via modem 722 such as, for example, one of the models available from Cradlepoint, Inc. (Boise, Id.), however, the data may alternatively be transferred to computer 710 via wireless technology.

FIG. 9A also shows a sensor module 730 including a plurality of cameras (e.g., visible spectrum cameras), inertial measurement unit (IMU), and GPS sensor. The sensor module is shown in communication with the computer 710 via USB connection.

The number and types of sensors may vary widely. Examples of sensors include, without limitation, visible spectrum cameras (e.g., a black and white, or RGB camera), depth sensors, ultrasound, GPS, odometry, IMU motion, radar, and infrared (IR) or multi-spectrum cameras.

In embodiments, a sensor module 730 includes multiple visible spectrum cameras. In a preferred embodiment, the system includes 6 visible spectrum cameras symmetrically distributed about the vehicle and arranged such that the focal length of the camera lens and orientation of the optics capture an image of 360 degrees from the vehicle. An exemplary visible spectrum sensor is the Intel® RealSense Depth Camera D455, manufactured by Intel Corporation (Santa Clara, Calif.).

In embodiments, different sensing modalities are combined into an integrated sensor including its own dedicated electronics. For example, the visible spectrum cameras can be paired with infrared spectrum depth-sensing cameras or time of flight cameras, as exemplified by the aforementioned Intel RealSense cameras, such that the cameras collectively capture and provide to the robot a three-dimensional view of the area 360 degrees around the robot.

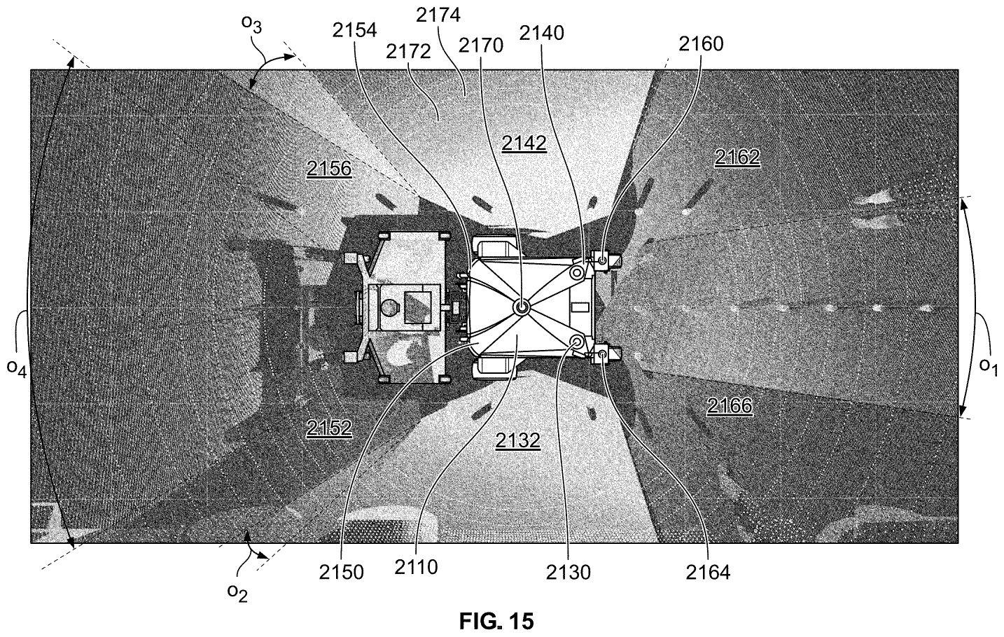

With reference to FIG. 15, an example of the camera and sensor coverage is shown in accordance with an embodiment of the invention where stippled areas are indicative of the visible light spectrum cameras and the expanding concentric circles represent the radiating 360 LIDAR. Collectively, the sensors and cameras achieve 360-degree coverage including redundant or areas of overlap (e.g., O1, O2, O3, O4) in which the computer can select the most relevant data.

The Inertial Measurement Unit (IMU) provides the robot with orientation (roll, pitch, yaw), including the robot's heading with respect to magnetic north as well as true north, as well as linear and angular accelerations. An exemplary IMU sensor is the Xsens Technologies MTI-30-2A8G4, manufactured by Xsens Technologies BV (Enschede, Netherlands).

The Global Positioning System (GPS) sensor estimates the robot's latitude, longitude, and altitude. An exemplary GPS sensor is the Emlid Reach M+, manufactured by Emlid Ltd (Hong Kong).

FIG. 9A also shows the computer 710 in communication with traction motor controller 740 for controlling the traction motor, and a first control area network (CAN1) 750 for communicating with the deck controllers. The traction motor controller receives drive speed targets from the computer over network 750 and provides the necessary electrical power to the two brushed DC motors (optionally brushless) driving the vehicle to achieve these speed targets using a built-in PID controller and feedback from encoders mounted on the motor shafts. An example of a traction motor controller is the GDC 3660 from Roboteq (USA).

In embodiments, steering is accomplished in a nonhonomic manner by sending independent wheel velocity commands to each individual traction controller on the left and right of the vehicle/robot in the form of a differential drive system.

The blade or deck motor controllers receive blade speed targets from the computer over network 750 and provide the necessary electrical power to the 3 motors driving cutting blades to achieve these speed targets using a built-in PID controller and feedback from hall effect sensors inside the motors. An example of a deck motor controller is the 1226BL from Curtis Instruments (USA).

A second control area network (CAN2) 760 is shown for managing charging. Preferably, a separate CANBUS network is dedicated to managing the charge rate with the charger. Prior to charging, the BMS sends messages to the charger to describe the allowable charge rate and amperage. lithe charger CANBUS is disconnected, the charging will cease to protect the batteries. Physically, there is a separate CANBUS because the physical layer of CANBUS has terminating resistors at both ends of the bus and the charger end may be a considerable distance from the BMS.

FIG. 9B is a sensor interface diagram of another AEM system 800 in accordance with an embodiment of the invention where the components in common with that shown in FIG. 9A are meant to be the same type of component and carry out the same function to the component described in FIG. 9A except where the context indicates otherwise.

Amongst other differences shown in the diagram in FIG. 9B from that shown in FIG. 9A is the dedicated wireless controller 810 to drive the robotic vehicle unit. An example of a suitable wireless controller is the Taranis X9 Lite S by FrSKY Electronics Co., Ltd (Wuxi, 214125, Jiangsu, China).

Software Flow Diagram

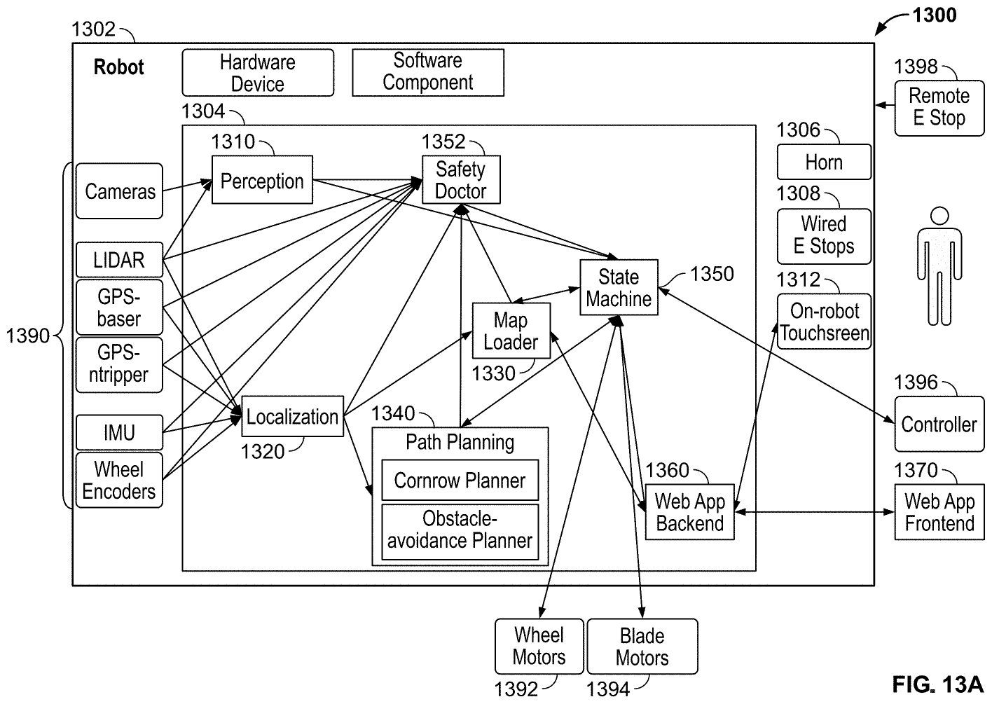

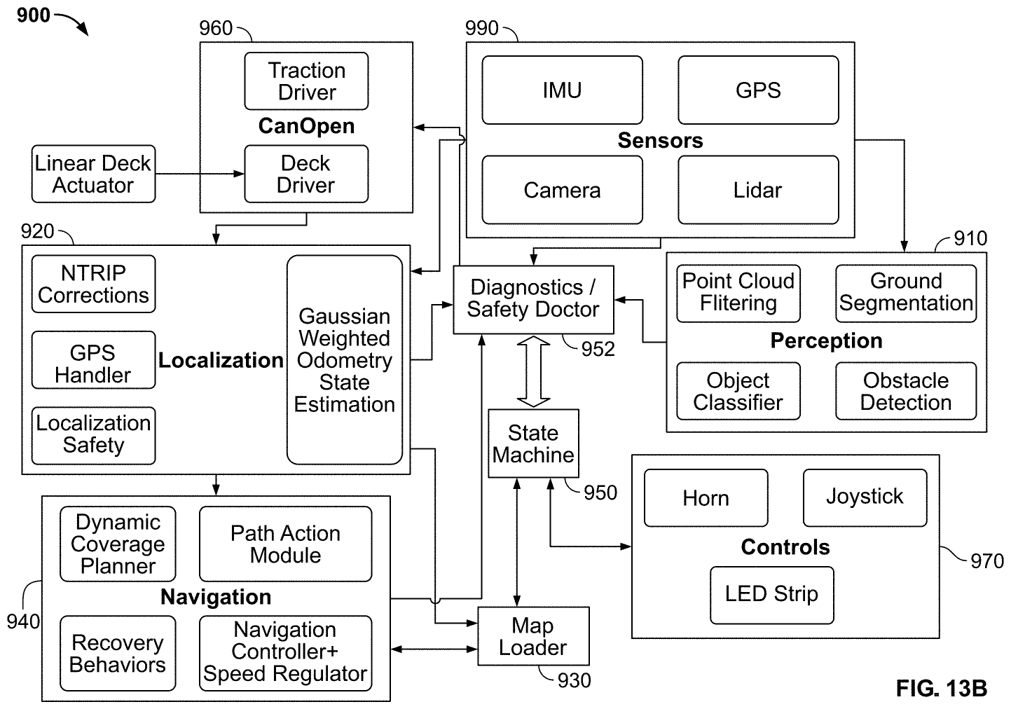

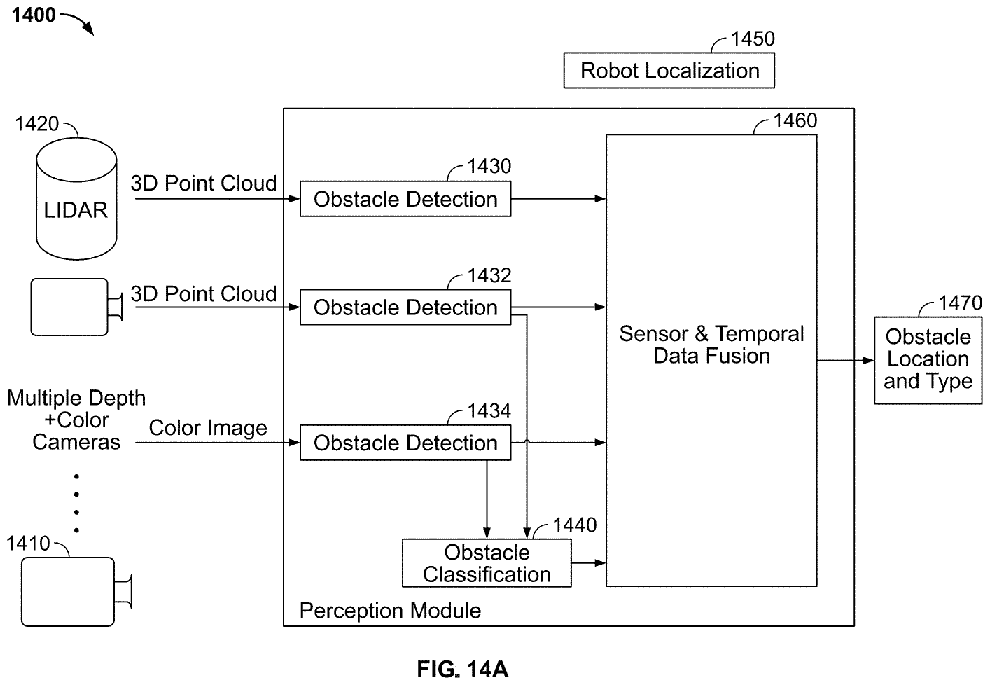

With reference to FIG. 13A, a high-level software block diagram of an AEM system 1300 is shown in accordance with an embodiment of the invention. AEM system 1300 is shown comprising a robot, namely mower 1302 and a plurality of software modules 1304. The software can be stored on a local storage device and include several modules, each of which is discussed in more detail herein. The software modules shown in FIG. 13A include: perception module 1310 for detecting obstacles along the path, localization module 1320 for determining location of the AEM, map loader 1330 for loading maps of the candidate area to mow, path planning module 1340 for determining the route of the AEM, state machine 1350 for managing the states of the AEM, safety module 1352 for preventing injuries during operation, and Web Apps 1360, 1370 to provide visibility and control to remote users via computing devices connected to the internet. Examples of computing devices include, but are not limited to, smartphones, tablets, notebooks, desktops and workstations.

FIG. 13A also shows exemplary hardware components on the robot 1302 for operating with software modules in accordance with embodiments of the invention. Particularly, and discussed further herein, the robot 1302 is shown having a wide range of sensors 1390, wheel motors 1392, deck motors 1394, horn 1306, wired emergency stop 1308, onboard touchscreen 1312, handheld controller 1396 (e.g., a wired or wireless controller for driving the vehicle as described above), and remote emergency stop 1398.

FIG. 13B shows a high-level software block diagram of an AEM system 900 in accordance with another embodiment of the invention. AEM system 900 is shown comprising a plurality of software modules and hardware. The software can be stored on a local storage device and include several modules, each of which is discussed in more detail herein. The software modules shown in FIG. 13B include: perception module 910 for detecting obstacles along the vehicle path, localization module 920 for determining location of the vehicle, map loader 930 for loading maps of the candidate area, path planning module 940 for determining the route of the vehicle, state machine 950 for managing the states of the system, safety module 952 for preventing injuries during operation, driver module 960, and external controls 970. The external controls 970 provide visibility and control to remote users via, e.g., a joystick. In embodiments, as discussed herein, the onboard computer may be accessed by an onboard touchscreen display or via a remote or portable computing device. The AEM system 900 preferably includes a wireless communication module to communicate with such computing devices. Examples of computing devices include, but are not limited to, smartphones, tablets, notebooks, desktops and workstations.

Perception Module

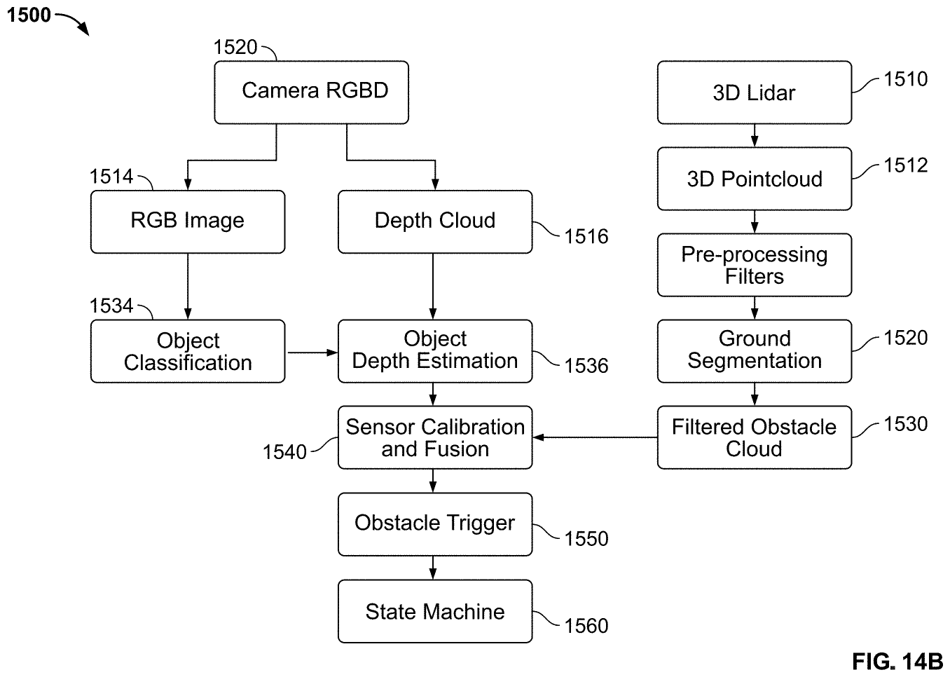

FIG. 14A is a more detailed block diagram of a perception software module 1400 of an AEM system in accordance with an embodiment of the invention. As described above, the perception module 1400 is intended to detect obstacles as the mower is operating.

The module 1400 shown in FIG. 14A receives data from multiple cameras 1410 (typically, color and depth cameras) and LIDAR 1420 for capturing image data of the surroundings. The image data from each sensor type can be fed in the form of a 3D pointcloud into detectors 1430, 1432, 1434 for detecting whether an obstacle is present. The detector(s) 1430, 1432, 1434 may be neural network-based.

Descriptions of examples of neural network approaches for detection include, for example, Ross, Girshick (2014), “Rich feature hierarchies for accurate object detection and semantic segmentation”, Proceedings of the IEEE Conference on Computer Vision and Pattern Recognition. IEEE. pp. 580-587; Girschick, Ross (2015), “Fast R-CNN”, Proceedings of the IEEE International Conference on Computer Vision, pp. 1440-1448; and Shaoqing, Ren (2015). “Faster R-CNN”, Advances in Neural Information Processing Systems, a rXiv:1506.01497.

FIG. 14A also shows object classifier 1440 for classifying the object detected from the detectors 1430, 1432, 1434. The object classifier is trained to recognize humans, vehicles, animals, etc. The classifier 1440 may be neural network-based.

Descriptions of examples of object classifiers include, for example, a trained convolutional neural network.

In embodiments, a convolutional neural network is trained. First, candidate obstacles are placed in the sensor field of view and image input data is generated and collected. In embodiments, the CNN is trained by positioning on a lawn one or more of the following objects: humans, trees, ponds, sand pits, and animals.

Next, the image data is labeled. Particularly, the image data is presented to a human user who identifies relevant objects in the image (classifies) and creates bounding boxes for the images (locates). The data from the human user is then recorded into the form of the output layer that the CNN should create when presented with the input image data.

Next, the input images and output layer are divided into training, validation and test sets. The training data set is presented to the model and periodically compared with the validation data set. The parameters of the CNN are adjusted based on the results of the validation set. The process is repeated multiple times (multi-stage). With each iteration, the weighting factors of the CNN can be modified. Examples of weighting factors adjusted to tune the model include, without limitation, the weights of the connections between each neuron in one layer of the CNN and each neuron in the next layer of the CNN.

Although a machine learning dataset creator is described above, the invention is not intended to be so limited except where recited in any appended claims. Indeed, a wide variety of trained models may be utilized or part of the subject invention.

FIG. 14A also shows data fusion module 1460 which receives inputs from obstacle detectors 1430, 1432, 1434, obstacle classifier 1400, and optionally, robot localization module 1450. In embodiments of the invention, the localization module 1450, discussed herein, is operable to provide global positioning location information of the robot mower to the fusion module.

Fusion module 1460 combines the obstacle detection data from each of the sensors (e.g., probabilities that an object is present), the classification data (e.g., probability the object is a human or another specific type of obstacle), the localization data (e.g., global position of the robot), and the time or clock and computes the obstacle location and type 1470. By having multiple redundant sensors as described, the safety and reliability of the obstacle detection system is increased, such that a failure of any one sensor (or even several sensors) does not compromise the safety of the overall system. As discussed herein, the output from the perception module is used to decide how to handle the particular obstacle, for example by stopping and alerting a human or by autonomously avoiding obstacles along the path of the mower. Additionally, in embodiments, the invention can include redundant computing of obstacles, classification, localization, and logic or decision rules such as optimized navigation behaviors, namely, speed regulation and path selection when approaching a living object versus a non-living object, for enhancing safety, and serving to provide fail safe operations.

With reference to FIG. 14B, another module 1500 for obstacle detection is shown in accordance with embodiments of the invention. The module shown in FIG. 14B utilizes a combination of camera sensors such as the LIDAR 1510 and the RGBD camera units 1520 to obtain a 3D pointcloud 1512, RGB Image 1514 and depth cloud 1516, respectively.

With reference to LIDAR data track, the ground surface is segmented from the 3D point cloud 1520.

Then, a filtered obstacle cloud 1530 is generated by probabilistically removing outliers for effective obstacle detection.

With reference to the RGBD camera track, a classifier 1534 as described above classifies the objects from the RGB image.

The depth data is applied to the object to generate an object depth estimation 1536.

The processed data from the RGBD and LIDAR cameras is calibrated to a single coordinate system and fused 1540.

In preferred embodiments, the data from each of the RGBD and LIDAR sensor units is evaluated and weighted for determining the presence of an obstacle 1550. Examples of logic rules include: (a) to determine which modality source to employ based on environmental conditions (e.g., night versus day), (b) to determine whether the object is living or nonliving, and to plan a subroute to avoid the obstacle accordingly, (c) to determine whether one sensor or type of sensor data is sufficient (e.g., dense enough) to capture smaller resolution obstacles, (d) to determine which combination of one or more sensors generate a sufficient field of view to avoid blind spots, and (e) to determine and bound a region of interest (e.g., an obstacle) as detected by the cameras and to determine an optimum distance from the region of interest based on the LIDAR data.

The obstacle type and location are then sent to state machine 1560.

FIG. 15 is an illustration of sensor/camera coverage in accordance with an embodiment of the invention. It depicts 360-degree scanning from the vehicle 2110. In particular, it shows the visible spectrum and depth sensing cameras (2130, 2140, 2150, 2154, 2160, 2164) and the LIDAR 2170, and the fields of view (2132, 2142, 2152, 2156, 2162, 2166, 2172, 2174, etc.) including regions of overlap (O1, O2, O3, O4). The robot has 360-degree perception data from the multiple sensors. If any one particular sensor were to be obstructed or otherwise fail, the robot would be able to detect the sensor failure by comparing its output to another sensor. The robot can then replace the data from the area covered by the suspect or offending sensor with that from an unobstructed or valid sensor.

The mower can also monitor the health of the grass using data from its cameras, LIDAR, feedback from the cutting deck motors, or other sensors. By including such sensors on an autonomous mobile platform (the mower) and reporting it for each location the mower covers, the system provides a far higher granularity of data than that possible from sensors installed in fixed locations. This data can be presented to the user in a cloud network for detailed visualization and analysis. These metrics help owners and operators identify adjustments that may need to be made, such as irrigation, seeding, aeration, or chemical sprays, increasing the health of their lawns and efficiency of their operations.

Localization Module

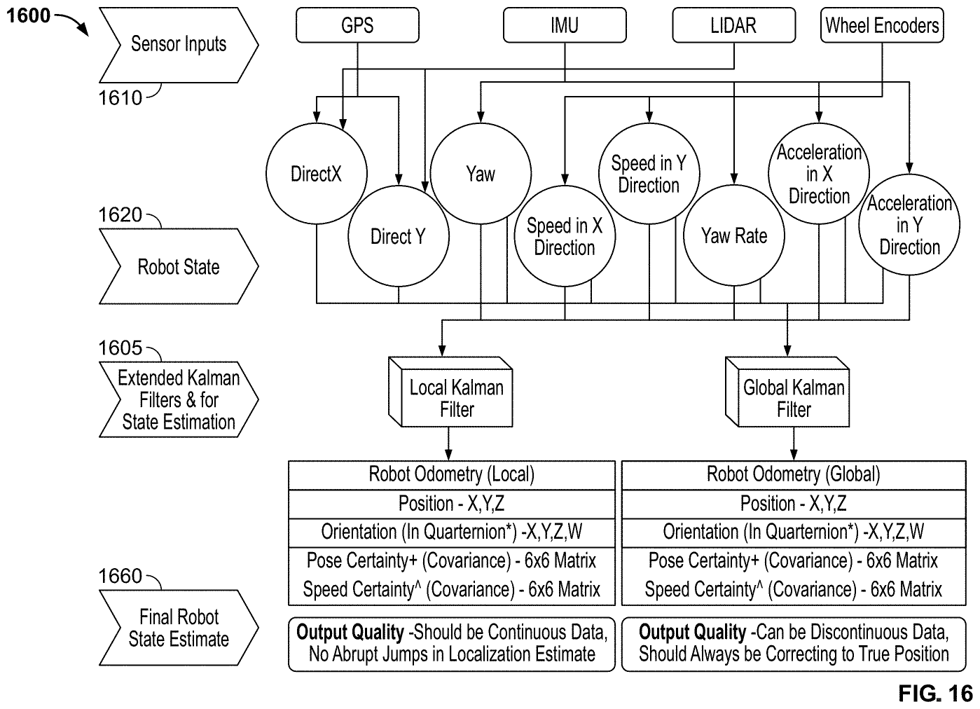

FIG. 16 is a block diagram of a localization module 1600 of an AEM system in accordance with an embodiment of the invention. As described herein, the localization module 1600 predicts local and global estimates for the robot mower.

The sensor inputs 1610 shown in FIG. 16 include: GPS, IMU, LIDAR, and wheel encoders.

An example of a suitable GPS sensor is the Reach M+, manufactured by Emlid Inc. (Hong Kong). The GPS generates latitude and longitude coordinates, which are converted to X and Y global coordinates. Examples of outputs from the GPS sensor include: GPS handler, localization safety, Baser and NTRIP. In embodiments, the GPS handler is operable to check GPS data and produce orientation information and magnetic declination corrections to the GPS data. The Localization Safety can gauge the health of position state estimates from each modality and determine threshold for failure. The Localization Safety can also suggest recovery or ask the robot to stop. Baser and NTRIP optionally can be combined into one node that provides internet-based latitude and longitude corrections to the singular GPS receiver on the robot.

An example of a suitable IMU sensor is the MTI-30-AHRS by Xsens Inc. (Enschede, Netherlands). The IMU generates values for roll, pitch, yaw, yaw rate, and linear as well as angular acceleration.

An example of a suitable LIDAR sensor is the OS1, manufactured by OUSTER (USA). The LIDAR generates 3D image data.

An example of a motor with a suitable wheel encoder is ASI Drives Thunder 1500 manufactured by ASI Drives (Montgomeryville, Pa.). The wheel encoder generates speed data for the vehicle.

The robot mower state 1620 indicates the current state of the robot mower based on the data generated by the sensor inputs.

Next, a state estimate is computed. In embodiments, a filter 1605 is applied (e.g., a Kalman type of filter may be applied) for both local and global state prediction. A Kalman filter is an algorithm for improving signal tracking. A Kalman filter generally includes a physical model of an object and uses the physical model to predict the next measurement (e.g., to where did the object move). Examples of types of Kalman filters that can be used in embodiments of the invention include, without limitation, the Extended Kalman Filter, or other versions of the Kalman Filter.

In embodiments, a global state estimate is computed using a plurality of sensors namely the GPS, IMU, Wheel Encoders, cameras and LIDAR. In embodiments of the invention, the LIDAR and the CAMERA use features from the environment to gauge the motion of the robot with an initialization base factor formulated from the Wheel Encoders, IMU and GPS. Both the LIDAR and the CAMERA position estimates are assigned a cost according to how reliable their internal noise parameters are, and how plausible the end data is with respect to the environment. This information pools into a gaussian state estimation and smoothing algorithm that runs an optimizing function to determine the best possible state estimate at any given point of time. In the event data from any of the modalities is deemed not sufficient or untrustworthy, that information is disregarded and another modality is used as a reliable source. Examples of scenarios where data is deemed unreliable or untrustworthy is where environmental conditions are too dark, too bright, the speed of rotation is too high or there is significant occlusion for the RGBD camera to procure reliable landmark information to generate a healthy position state estimate. In the latter event where there is a significant occlusion in the RGBD field of view, in embodiments, the location algorithm is operable to select the position state estimate procured from the Lidar which tends to be more tolerant to this type of RGBD failure. Preferably, each modality is weighted and the highest weighted modality provides a bias to correct the data streaming from the lower reliable modalities during operation. This is done by first formulating the data from each modality as a non-linear problem and then running optimizing functions to minimize the error and generating a health score.

FIG. 16 shows computing the final position 1660 based on the local and global Kalman Filters. Local and global values can be computed for position (e.g., X, Y, Z), orientation, pose certainty, speed certainty. Additionally, an evaluation of the estimated data quality can be output (e.g., is the data continuous-no abrupt jumps in localization estimate).

Path Planning

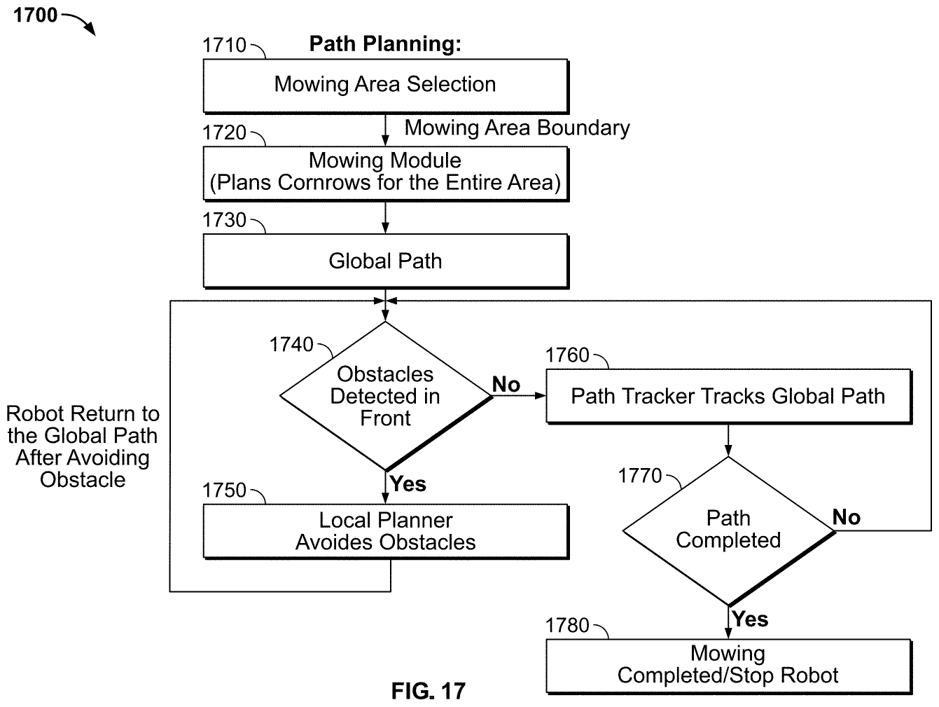

FIG. 17 is a flow diagram of a path planning software method 1700 of an AEM system in accordance with an embodiment of the invention.

Step 1710 states selecting the mowing area. This step may be performed by, for example, (a) manually using a controller to guide the mower along the boundary of the mowing area, (b) drawing/denoting the boundary over a satellite or top view of the target area on a display in an App, or (c) selecting a boundary from a database of previously-determined or known boundaries.

In a preferred embodiment, boundary mapping is performed as follows: (a) the user activates a boundary generation module, (b) the user drives the vehicle (via joystick for example) along a perimeter of the target area, (c) the computer system records points during the drive, and (d) the computer calculates a multi-sided polygon to encompass the points. In a preferred embodiment, [symbol] Gaussian-based localization described herein.

Optionally, the computer can be programmed to automatically compute the geometric boundary shape as each point is recorded. Then the user confirms the boundary when the boundary is deemed acceptable to the user. For example, the user may continue to generate or record more points until the boundary appears relatively smooth and does not cut off regions of the target area. To this end, it is to be understood that the number of recorded points may vary in order to generate the boundary. In embodiments, the number of recorded points is at least 3, and typically between 4-100,000, and in embodiments, between 10-1000 points.

It is also to be understood that in embodiments of the invention, the driving need not form a closed shape such as a circle or polygon, the above-described algorithm computes a closed shape polygon based on the recorded points whether the points form an enclosed boundary or not.

In an alternative embodiment, instead of driving the mower, the user traces/draws the boundary or portions of the boundary via various user interfaces such as an onboard touch screen or portable computing device. The computer is operable to carry out the remainder of the steps described above in order to enclose the recorded points, and finalize the boundary.

Step 1720 states mowing module which is operable to compute a global path 1730 including a particular mowing pattern within the boundary (e.g., to plan rows for the entire area). This step may be performed on a computer and based on the selected mowing area, desired completion time, the desired overlap between successive rows (e.g., between 10-50 cm), desired pattern (e.g., mow alternating rows to minimize impact on grass), the type of turn desired at the end of each row (e.g., U-turn, or Y-turn), the desired direction of the rows, and potentially other inputs. This step ensures the robot will cover the entirety of the mowing area when mowing.

In embodiments, and after the target boundary has been computed, a coverage planner algorithm determines optimal coverage pattern within the boundary. In embodiments, the optimal coverage pattern is based on reducing the number of turns, reducing mow time, and/or increasing efficiency from a power consumption standpoint. In embodiments, the user may input to the path planner various options such as grass height or mowing directions. Examples of mowing directions can include patterns such as hatched, cross, concentric circular, concentric rectangular, or solid or any combination of the patterns. Additionally, a target area may be divided into multiple subareas, each of which has a unique route and mowing characteristics. For example, the golf putting green desirably has a short height, and is row-free. In contrast, the rough may be cut long, and have one or more row patterns. Customizing mowing as described herein (whether based on user input or automatically computing to optimize mowing efficiency or another goal) serves to maintain any aesthetic requirement that may be desired for a particular lawn whether golf, soccer, school ground, park, etc.

Step 1740 states to query for obstacles in the path of the mower. Obstacles are detected by sensors and a perception module as described herein. If obstacles are detected, the robot can be set to stop for the obstacles, or to avoid them. If avoiding obstacles, the local planner 1750 calculates a buffer or padding form the obstacle, and detour to avoid the obstacle and return to the global path 1730. In embodiments, the local planner 1750 is a software module that computes a short path around the obstacle and back to the original mowing row by evaluating many possible paths around the obstacle and choosing one that maximizes metrics such as proximity to the original row path, proximity to the goal (returning to the row beyond the obstacle) and avoids getting close to obstacles. In embodiments, obstacles are populated from multiple modalities on a two-dimensional map grid representation in the form of weighted occupancy with added padding as a safety layer. The obstacles are automatically marked and cleared off of the map grid according to the perspective of each sensor modality. The path for the robot is also defined on the same map grid where the footprint of the robot is checked against obstacle occupancy to determine a safe stoppage recovery mechanism and a replanning solution. Obstacle marking on this map grid may be annotated and labeled differently for representation and classification of multiple types of obstacles (e.g., living or non-living) so as to have the path planner choose replanning routes in accordance with safety. In embodiments, the detour would comprise a greater distance from a living obstacle than a non-living obstacle.

If obstacles are not detected 1760, the path tracker continues tracking along the global path.

As the mower follows the global path, step 1770 queries whether the path is completed. If the path is not completed, the mower continues along the path and continuously checks for obstacles. If the path is completed 1770, the mowing is halted and the robot mower is stopped 1780.

In preferred embodiments the mower is steered by independently adjusting the rotation speed of the driving wheels 114, a method commonly known as differential steering. In such embodiments the non-driving wheels of the robot are mounted on swiveling casters.

State Machine

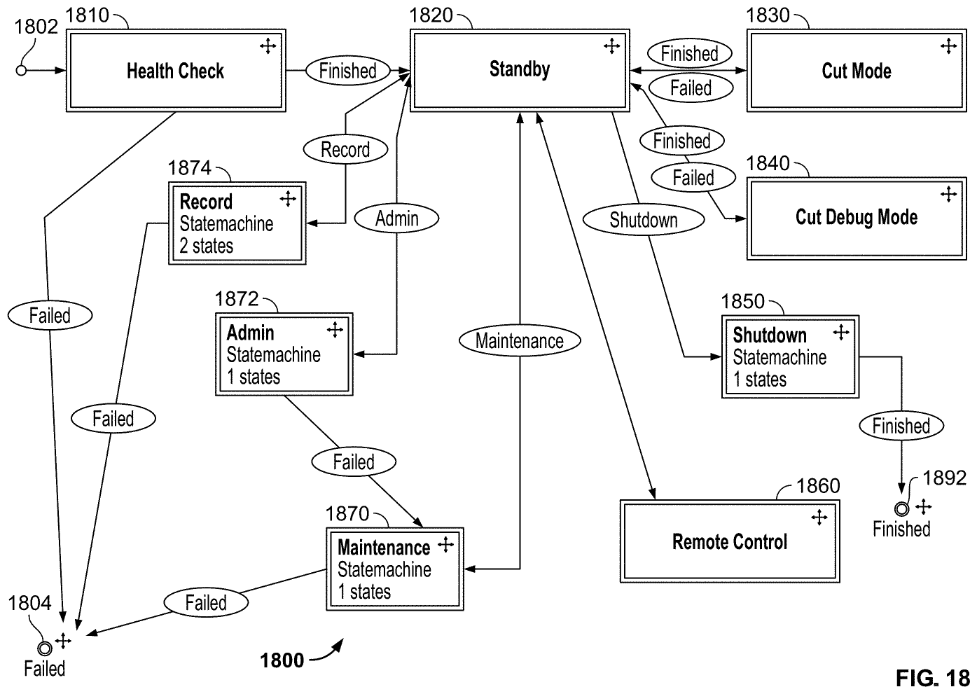

FIG. 18 is a block diagram of a state machine 1800 of an AEM system in accordance with an embodiment of the invention. The state machine module 1800 is operable to receive information and data from the various modules as described and shown in, e.g., FIGS. 13A, 13B and to update and store the status of the system. Several states are shown in FIG. 18 including: health check 1810, standby 1820, cut mode 1830, cut debug mode 1840, shutdown 1850, remote control 1860, maintenance 1870, admin 1872, and record 1874.

After the system is turned on (1802), a health check is performed 1810. Particularly, the health check verifies that important components of the system are functioning properly. This includes, but is not necessarily limited to, the blade deck, GPS receivers, LIDAR, battery management system, and the wheel motor controllers. If the health check does not pass, the system state is failed 1804. If the health check passes, the system state is standby 1820.

From the standby state, a human operator can transition the robot to other states as desired. To operate the robot using a remote control, for example, the operator sets the robot to Remote Control mode 1860. When ready for autonomous mowing, the operator sets the robot to Cut Mode 1830. The operator can cycle between these modes an arbitrary number of times, and thus mow a large property consisting of multiple mowing areas.

Cloud Network

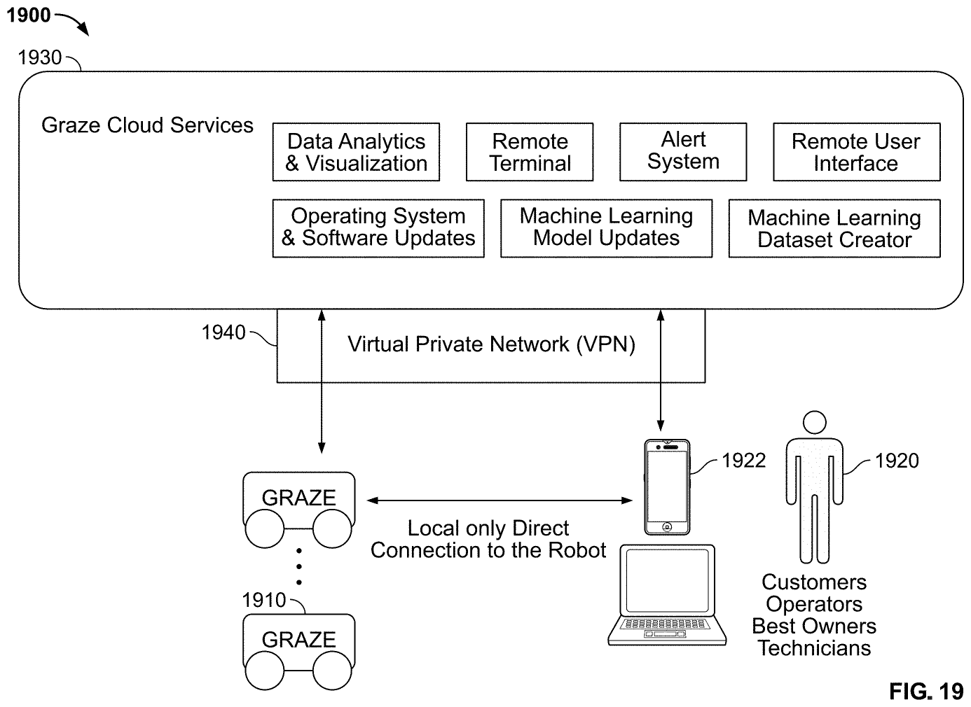

FIG. 19 is a block diagram of a cloud-based system 1900 of an AEM system in accordance with an embodiment of the invention. One or more robot mowers 1910 are shown in communication with local computing devices 1922 for operators 1920. Examples of computing devices include, without limitation, smartphones, tablets, and computer workstations. The operators may command the robot mower via the local computing devices. In embodiments, a local dedicated command center includes a computing device to control and monitor the AEM system(s).

Both the robot mowers 1910 and local computing devices 1922 are also operable or programmed to communicate with a remote server (e.g., remote cloud-based server) 1930 via a public network, and more preferably a virtual private network (VPN) 1940. Each of the robot mowers and computing devices can include wireless communication modules or interfaces to send and receive data with one another. Examples of suitable wireless communication technologies are Cellular, Bluetooth, and Wi-Fi.

Cloud services 1930 can include: remote terminal and user interface, alert systems, operating system and software updates, and data analytics and visualization, machine learning model updates (e.g., for the localization, obstacle detection, and obstacle classification models described herein), and machine learning dataset creator. In embodiments, cloud services can include a command center to review and control the robot mowers.

The machine learning dataset creator semi-automatically creates a dataset to improve the performance of machine learning models deployed on the robot. For example, if one wants to improve the robot fleet's performance in identifying dogs, one could provide a model trained to identify dogs that has some baseline performance with a relatively high false positive rate. This model can be deployed on the robot fleet and used to automatically get many images of dogs as well as objects that the robots falsely classify as dogs. In such a manner a large dataset can be created, and after labeling and retraining the model which images contain the real dogs, an improved machine learning model to identify dogs is created.

Graphical User Interface

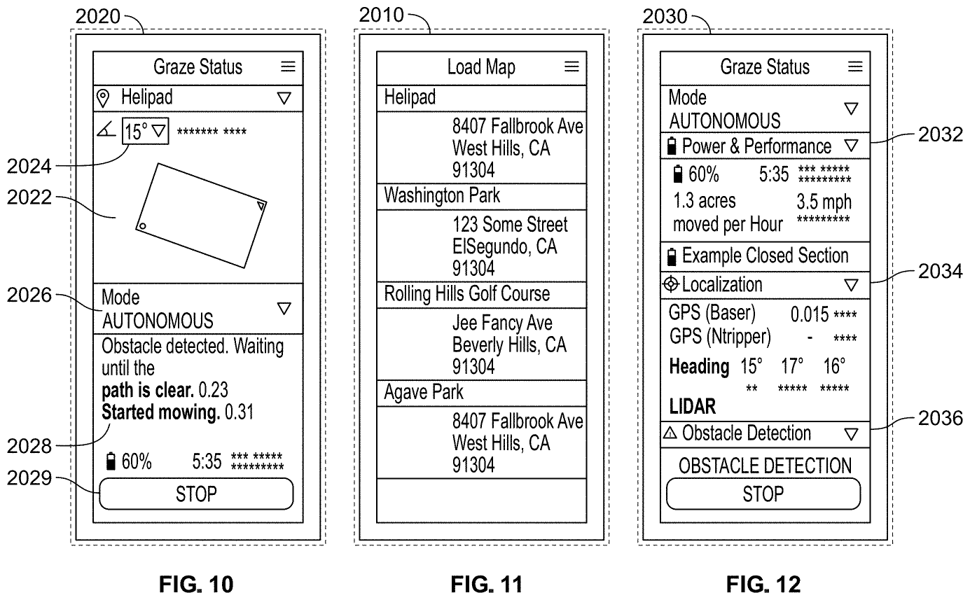

FIGS. 10-12 illustrate various screen shots for a graphical user interface (GUI) in accordance with an embodiment of the invention.

With reference to FIG. 11, the GUI 2010 shows candidate maps to load for mowing. The operator may select a map to load for path planning as described above. In embodiments, an App is programmed to automatically generate one or more candidate maps based on the detected location of the operator.

With reference to FIG. 10, the GUI 2020 shows an enlarged view of the selected map including a tab for selecting a mowing angle. As described above, the instructions are communicated to the robot mower to be performed by the mower.

The GUI 2020 also shows a tab for mode 2026. The operator may select, e.g., a manual or autonomous mode as described above.

The GUI 2020 also shows a tab for status 2028 including battery life and mowing time.

The GUI 2020 also shows a tab for stop 2029. The operator can stop the vehicle at any time as described above.

With reference to FIG. 12, the GUI 2030 shows a tab for various metrics such as power and performance 2032. Other information can include battery life and estimated time for completion.

The GUI 2030 also shows a tab for localization 2034 to report GPS information. In embodiments of the invention, one GPS unit performs internet-based corrections to position estimates in latitude and longitude (e.g., NTRIP). However, other embodiments of the invention may incorporate or utilize other GPS configurations including, for example, a local (non-internet) base station to perform position estimates in latitude and longitude (e.g., baser).

The GUI 2030 also shows a tab for obstacle detection 2036 to indicate the detection of an object, as described above.

### Alternative Embodiments

Although various embodiments have been described above, it is to be understood the invention may vary and include additional or less components and steps than that described above. For example, in another embodiment, the vehicle is operable independent from a particular type of attachment (e.g., the mowing deck). The main autonomous vehicle can include a drive means (e.g., one or more drive wheels), brake and brake controller, a plurality of sensors that are utilized for localization, navigation and perception, and a universal port/interface for power supply, data/communication bus and mechanical docking support between the vehicle and the slave attachment. This enables the vehicle to support a wide variety of attachments.

On-board electronics can be programmed or operable to automatically detect the type of attachment, and to dynamically configure the system state in accordance with the detected slave attachment such that the robot can autonomously fulfill other functions of value in the landscaping or other industries, including but not limited to grass or brush mowing with a reel mower, reciprocating dual blade trimmer, or rotating weed Wacker using a flexible disposable string. Other applications and attachments that may be incorporated into the system include, without limitation: aerating deck including a rotating or actuatable divot or hole puncher; irrigation deck including a water tank and a flow-controlled nozzle, and optionally a water pump; fertilizing deck including a hopper and controllable release valve to control flowrate of fertilizer dispensed, chemical spraying deck including a tank and flow controlled-valve, golf ball collection assembly including a mechanical and/or suction action to pick up golf balls and store in receptacle; and a security deck for providing surveillance and security cameras, sirens, or lights not present on the main unit. The main unit computer is operable to recognize each deck or attachment, and to operate according to the application protocol or module. As described above, the computer and electronics may have application modules stored locally on the main unit computer, may be received from the accessory deck or attachment via the umbilical cable, or may be downloaded from the cloud services through a VPN or public network.

Still, in other embodiments, the system is attachment-free, and operates autonomously for a wide variety of applications such as, for example, security and detection of objects, inspection of object (e.g., inspection of solar panels, grass cut or pattern or completeness, or irrigation systems), etc.

Still other modifications and variations can be made to the disclosed embodiments without departing from the subject invention.

1. An autonomous electric mower comprises:
a computer;
a Lidar sensor;
a color camera;
a depth sensing camera;
a GPS sensor;
at least one traction motor and drive wheel coupled to the traction motor; and
at least one blade motor and blade coupled to the blade motor for cutting; and wherein the computer is operable to:
determine the mower location based on at least one of the Lidar sensor, color camera, GPS, and depth sensing camera;
instruct the mower to move along a path according to a predetermined route plan;
instruct the mower to cut according to a predetermined cutting pattern;
monitor the path for obstacles as the mower is moving along the path and cutting based on data from the color camera, depth camera, and LIDAR sensor;
instruct the mower to continue moving along the path and to continue cutting if data from at least one of the color camera, depth camera, and LIDAR sensor is unobstructed even if one of the color camera, depth sensing camera, and LIDAR sensor is obstructed.

2. The autonomous electric mower of claim 1, wherein the mower comprises a vehicle body, and the Lidar sensor is arranged to have a 360-degree view from the vehicle body.

3. (canceled)

4. (canceled)

5. (canceled)

6. (canceled)

7. An autonomous electric mower for mowing a lawn comprising:
a computer;
a Lidar sensor;
a plurality of depth sensing cameras; and
a plurality of color cameras,
wherein the computer is operable, based on the data generated from each of the Lidar sensor, depth sensing cameras, and color cameras, to:
determine the location of the mower;
detect an obstacle; and
instruct the mower to avoid the obstacle.

8. The autonomous electric mower of claim 7, wherein the computer applies a first machine learning image-based sensor processing model to determine the location of the mower and a second machine learning image-based sensor processing model to detect the obstacle.

9. The autonomous electric mower of claim 8, wherein the computer is further operable to compare the data of a first sensor type to the data of a second sensor type to validate the location of the mower and presence of the obstacle.

10. The autonomous electric mower of claim 9, wherein the computer is further operable to instruct the mower to continue mowing when one sensor is obstructed by use of data generated from at least one of the unobstructed sensors.

11. The autonomous electric mower of claim 7, further comprising at least one cutting blade defining a cutting plane, and at least one blade motor for rotating the cutting blade, and at least one cutting-plane lift motor for adjusting the height of the cutting blade relative to the ground.

12. The autonomous electric mower of claim 11, wherein the computer is operable to monitor the power during mowing, and to adjust the power during mowing based on controlling the at least one blade motor, vehicle ground speed, and the cutting plane lift motor.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. An autonomous electric vehicle system comprising a main robotic unit and slave attachment, wherein the main robotic unit comprises at least one traction motor and wheel, a plurality of sensors and cameras for localization, navigation and perception, and an attachment hitch for power supply, data/communication, and mechanically connecting the vehicle to a slave attachment; and the slave attachment.

29. The autonomous electric vehicle system of claim 28, wherein the slave attachment is a mowing deck.

30. An AEM system comprising: a perception module, route planning module, localization module, blade cutting module, and navigation module, wherein the navigation module comprises a traction controller.

31. The system of claim 30, wherein the blade cutting module includes a height adjustment motor and dedicated controller for adjusting the height of the blade plane, and wherein the blade cutting module is operable to optimize mowing efficiency by adjusting the height of the blade plane during mowing.

32. (canceled)

33. (canceled)

34. (canceled)

35. (canceled)

36. The autonomous electric mower of claim 1, wherein the computer is programmed and operable to compute a detour if an obstacle is detected in the path of mower.

37. The autonomous electric mower of claim 7, wherein the computer is programmed and operable to compute a global path for the mower to mow the lawn.

38. The autonomous electric mower of claim 37, wherein the computer is programmed and operable to compute a local path if an obstacle is detected, and wherein the local path departs the global path, avoids the obstacle, and returns to the global path.

39. (canceled)
